(19) United States
(12) Patent Application Publication
(10) Pub. No.: US 2017/0026630 A1
(43) Pub. Date: Jan. 26, 2017

(54) METHOD, APPARATUS, AND COMPUTER PROGRAM PRODUCT FOR ROBUST IMAGE REGISTRATION BASED ON DEEP SPARSE REPRESENTATION

(71) Applicant: Nokia Technologies Oy, Espoo (FI)

(72) Inventors: Xin Chen, Evanston, IL (US); Junzhou Huang, Grapevine, TX (US); Yeqing Li, Arlington, TX (US)

(21) Appl. No.: 14/803,933

(22) Filed: Jul. 20, 2015

(51) Int. Cl. H04N 13/00; G06T 7/00; H04N 13/02

(52) U.S. Cl. CPC H04N 13/0014; H04N 13/0022; H04N 13/0271; G06T 7/0028; G06T 7/0051; H04N 2013/0081; G06T 2207/10021; G06T 2207/20092

(57) ABSTRACT

A method, apparatus, and computer program product are provided for providing personalized depth of field perception for omnidirectional video. A method is provided that includes generating, by a processor, a three-dimensional reconstruction of content from an omnidirectional capture device; determining a camera pose of an end user device in relation to the omnidirectional capture device content; identifying an object of interest in the content based in part on the camera pose of the end user device; generating an artificial depth of field for the content wherein the object of interest is in focus; and causing a personalized content view to be provided based on the object of interest and the artificial depth of field. A corresponding apparatus and a computer program product are also provided.

### TECHNOLOGICAL FIELD

An example embodiment of the present invention relates generally to remote sensing and simultaneous multi-image registration.

### BACKGROUND

In many real-world applications of multi-image registration, the images have significantly different appearances due to the intensity variations. This is particularly challenging for satellite/aerial imaging at different times of the day, seasons, years, from different altitude and view angle, by different sensors, etc. However, there is no single pair of images of the same object when examined at reasonable level of details due to intrinsic and extrinsic variations. Many existing intensity based methods may fail to solve these challenging problems.

Image registration aims to find the geometrical transformation to align two or multiple images into the same coordinate system. The geometrical transformation to be estimated can be either rigid, affine, piecewise rigid or non-rigid. Non-rigid registration is the most challenging task. Based on the features used in non-rigid registration, existing methods can be classified into feature-based registration and intensity-based registration. Embodiments of the present invention provide for multi-image registration using their intensities.

### BRIEF SUMMARY

Methods, apparatuses, and computer program products are therefore provided according to example embodiments of the present invention to provide robust image registration based on deep sparse representation for multi-image registration.

Embodiments of the present invention provide a novel method based on the deep sparse representation for multi-image registration. It is inspired by the fact that the image gradients are much more stationary than the intensities, especially when severe intensity distortions exist. In embodiments of the present invention, images are registered in the gradient domain, which intuitively leads to more accurate registration results.

Registration experiments on remote-sensing images demonstrate the accuracy and efficiency of the method provided by the example embodiments. An example of registering aerial image and true orthophotos using this method is provided herein. Intuitively, gradient field is robust to a wide range of registration applications with intensity artifacts/outliers. To solve the minimization problem, an efficient algorithm is provided based on the modified gradient descent method. The proposed algorithm is based on the Augmented Lagrange Multiplier (ALM) method. Experiments on synthetic and real-world images demonstrate that embodiments of the present invention are more robust, efficient, and accurate than other techniques, such as Robust Alignment by Sparse and Low-rank decomposition (RASL) and Transformed Grassmannian Robust Adaptive Subspace Tracking Algorithm (t-GRASTA).

In one embodiment, a method is provided that at least includes receiving a plurality of images to be registered; determining, by a processor, an image tensor based on the received plurality of images; sparsifying, by the processor, the image tensor into a gradient tensor; separating out a spare error tensor from the gradient tensor; sparsifying the gradient tensor in a frequency domain; and obtaining an extremely sparse frequency tensor.

In some embodiments, the method may further comprise wherein determining the image tensor further comprises arranging the plurality of images into a three-dimensional tensor having a size w×h×N. In some embodiments, the method may further comprise providing a transformation parameter, a plurality of aligned images, and a registration error.

In some embodiments, the method may further comprise registering the plurality of images using a deep sparse representation provided by

$${min}_{A , E , τ} {‖ {F}_{N} A ‖}_{1} + λ {‖ E ‖}_{1} , subject to ∇ D ∘ τ = A + E ,$$

where F_{N} denotes Fourier transform in a third direction, ∇D∘τ=[vec(I₁⁰), vec(I₂⁰), . . . , vec(I_{N}⁰)] is a M by N real matrix, vec(x) denotes vectorizing an image x, ∇D=\sqrt{(∇ₓD)²+(∇_{y}D)²} denotes a gradient along two spatial directions, vec(Iₜ⁰) denotes image Iₜ warped by τₜ for t=1, 2, . . . , N, A represents the aligned images, and E denotes the sparse error.

In some embodiments, the method may further comprise wherein the deep sparse representation imposes a sparse constraint on Fourier coefficients of A, the matrix of aligned images.

In some embodiments, the method may further comprise wherein the plurality of images to be registered comprise remote-sensing images.

In some embodiments, the method may further comprise wherein sparsifying the image tensor into the gradient tensor and separating out the sparse error tensor from the gradient tensor comprises sparsifying and separating out severe intensity distortions and partial occlusions.

In one embodiments, an apparatus is provided comprising at least one processor and at least one memory including computer program instructions, the at least one memory and the computer program instructions, with the at least one processor, causing the apparatus at least to: receive a plurality of images to be registered; determine an image tensor based on the received plurality of images; sparsify the image tensor into a gradient tensor; separate out a spare error tensor from the gradient tensor; sparsify the gradient tensor in a frequency domain; and obtain an extremely sparse frequency tensor.

In some embodiments, the apparatus may further comprise wherein determining the image tensor further comprises arranging the plurality of images into a three-dimensional tensor having a size w×h×N.

In some embodiments, the apparatus may further comprise the at least one memory and the computer program instructions, with the at least one processor, causing the apparatus to provide a transformation parameter, a plurality of aligned images, and a registration error.

In some embodiments, the apparatus may further comprise the at least one memory and the computer program instructions, with the at least one processor, causing the apparatus to register the plurality of images using a deep sparse representation provided by

$${min}_{A , E , τ} {‖ {F}_{N} A ‖}_{1} + λ {‖ E ‖}_{1} , subject to ∇ D ∘ τ = A + E ,$$

where F_{N} denotes Fourier transform in a third direction, ∇D∘τ=[vec(I₁⁰), vec(I₂⁰), . . . , vec(I_{N}⁰)] is a M by N real matrix, vec(x) denotes vectorizing an image x, ∇D=\sqrt{(∇ₓD)²+(∇_{y}D)²} denotes a gradient along two spatial directions, vec(Iₜ⁰) denotes image Iₜ warped by τₜ for t=1, 2, . . . , N, A represents the aligned images, and E denotes the sparse error.

In some embodiments, the apparatus may further comprise wherein the deep sparse representation imposes a sparse constraint on Fourier coefficients of A, the matrix of aligned images.

In some embodiments, the apparatus may further comprise wherein the plurality of images to be registered comprise remote-sensing images.

In some embodiments, the apparatus may further comprise wherein sparsifying the image tensor into the gradient tensor and separating out the sparse error tensor from the gradient tensor comprises sparsifying and separating out severe intensity distortions and partial occlusions.

In one embodiment a computer program product is provided comprising at least one non-transitory computer-readable storage medium bearing computer program instructions embodied therein for use with a computer, the computer program instructions comprising program instructions, when executed, causing the computer at least to: receive a plurality of images to be registered; determine an image tensor based on the received plurality of images; sparsify the image tensor into a gradient tensor; separate out a spare error tensor from the gradient tensor; sparsify the gradient tensor in a frequency domain; and obtain an extremely sparse frequency tensor.

In some embodiments, the computer program product may further comprise wherein determining the image tensor further comprises arranging the plurality of images into a three-dimensional tensor having a size w×h×N.

In some embodiments, the computer program product may further comprise the computer program instructions comprising program instructions, when executed, causing the computer to provide a transformation parameter, a plurality of aligned images, and a registration error.

In some embodiments, the computer program product may further comprise the computer program instructions comprising program instructions, when executed, causing the computer to register the plurality of images using a deep sparse representation provided by

$${min}_{A , E , τ} {‖ {F}_{N} A ‖}_{1} + λ {‖ E ‖}_{1} , subject to ∇ D ∘ τ = A + E ,$$

where F_{N} denotes Fourier transform in a third direction, ∇D∘τ=[vec(I₁⁰), vec(I₂⁰), . . . , vec(I_{N}⁰)] is a M by N real matrix, vec(x) denotes vectorizing an image x, ∇D=\sqrt{(∇ₓD)²+(∇_{y}D)²} denotes a gradient along two spatial directions, vec(Iₜ⁰) denotes image Iₜ warped by τₜ for t=1, 2, . . . , N, A represents the aligned images, and E denotes the sparse error.

In some embodiments, the computer program product may further comprise wherein the deep sparse representation imposes a sparse constraint on Fourier coefficients of A, the matrix of aligned images.

In some embodiments, the computer program product may further comprise wherein the plurality of images to be registered comprise remote-sensing images.

In some embodiments, the computer program product may further comprise wherein sparsifying the image tensor into the gradient tensor and separating out the sparse error tensor from the gradient tensor comprises sparsifying and separating out severe intensity distortions and partial occlusions.

In one embodiment, an apparatus is provided comprising: means for receiving a plurality of images to be registered; means for determining an image tensor based on the received plurality of images; means for sparsifying the image tensor into a gradient tensor; means for separating out a sparse error tensor from the gradient tensor; means for sparsifying the gradient tensor in a frequency domain; and means for obtaining an extremely sparse frequency tensor.

In some embodiments, the apparatus may further comprise wherein determining the image tensor further comprises arranging the plurality of images into a three-dimensional tensor having a size w×h×N.

In some embodiments, the apparatus may further comprise means for providing a transformation parameter, a plurality of aligned images, and a registration error.

In some embodiments, the apparatus may further comprise means for registering the plurality of images using a deep sparse representation provided by

$${min}_{A , E , τ} {‖ {F}_{N} A ‖}_{1} + λ {‖ E ‖}_{1} , subject to ∇ D ∘ τ = A + E ,$$

where F_{N} denotes Fourier transform in a third direction, ∇D∘τ=[vec(I₁⁰), vec(I₂⁰), . . . , vec(I_{N}⁰)] is a M by N real matrix, vec(x) denotes vectorizing an image x, ∇D=\sqrt{(∇ₓD)²+(∇_{y}D)²} denotes a gradient along two spatial directions, vec(Iₜ⁰) denotes image Iₜ warped by τₜ for t=1, 2, . . . , N, A represents the aligned images, and E denotes the sparse error.

In some embodiments, the apparatus may further comprise wherein the deep sparse representation imposes a sparse constraint on Fourier coefficients of A, the matrix of aligned images.

In some embodiments, the apparatus may further comprise wherein the plurality of images to be registered comprise remote-sensing images.

In some embodiments, the apparatus may further comprise wherein sparsifying the image tensor into the gradient tensor and separating out the sparse error tensor from the gradient tensor comprises sparsifying and separating out severe intensity distortions and partial occlusions.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 illustrates a block diagram of an apparatus that may be specifically configured in accordance with an example embodiment of the present invention;

FIG. 2 illustrates an example process of deep sparse representation of optimally registered images in accordance with example embodiments of the present invention;

FIG. 3 illustrates sample images used in the multi-image registration examples described herein;

FIGS. 4a-4g illustrate a first example of multi-image registration in accordance with an example embodiment of the present invention with comparison to other techniques;

FIGS. 5a-5g illustrate a first example of multi-image registration in accordance with an example embodiment of the present invention with comparison to other techniques;

FIGS. 6a-6g illustrate a first example of multi-image registration in accordance with an example embodiment of the present invention with comparison to other techniques;

FIGS. 7a-7g illustrate a first example of multi-image registration in accordance with an example embodiment of the present invention with comparison to other techniques;

FIGS. 8a-8g illustrate a first example of multi-image registration in accordance with an example embodiment of the present invention with comparison to other techniques;

FIG. 9 provides a flow chart illustrating operations for robust multi-image registration based on deep sparse representation in accordance with an example embodiment of the present invention; and

FIG. 10 provides a flow chart illustrating operations for robust multi-image registration based on deep sparse representation in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data”, “content”, “information”, and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium”, which refers to a non-transitory physical storage medium (e.g., volatile or non-volatile memory device), can be differentiated from a “computer-readable transmission medium,” which refers to an electromagnetic signal.

Methods, apparatuses, and computer program products are provided in accordance with example embodiments of the present invention to provide to provide robust image registration based on deep sparse representation for multi-image registration.

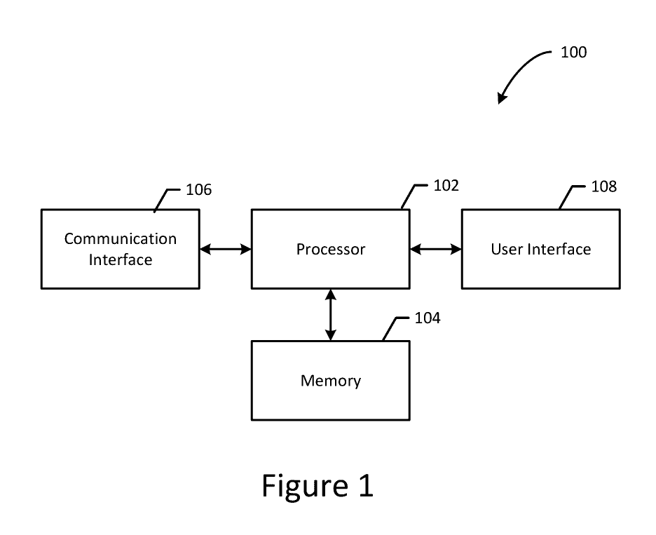

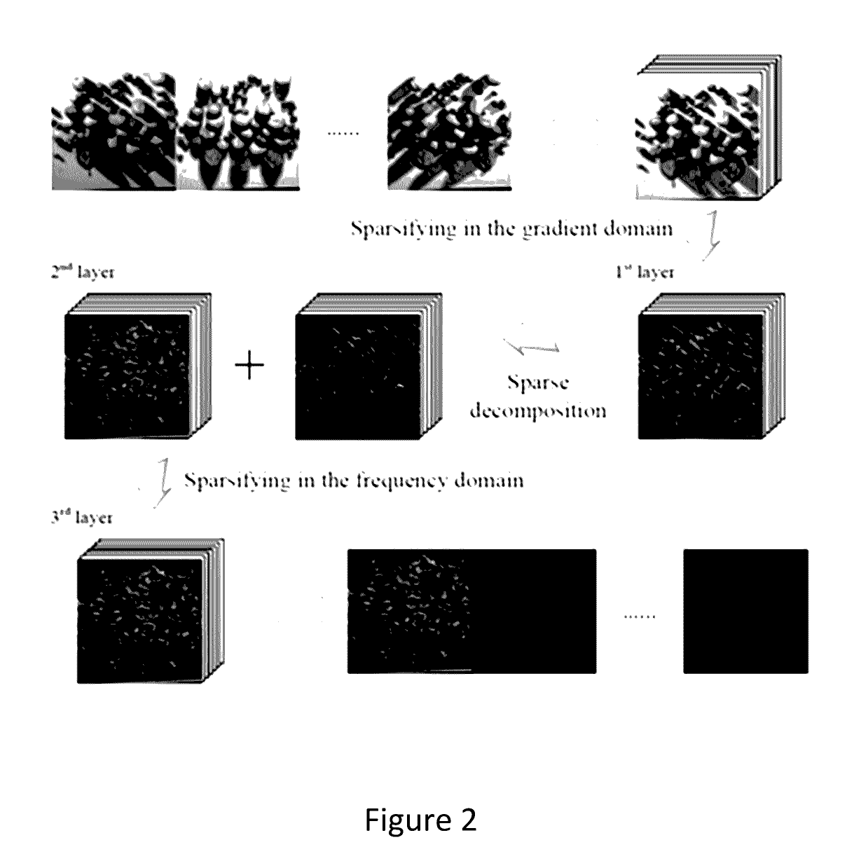

FIG. 1 illustrates an example of an apparatus 100 that may be used in embodiments of the present invention and that may perform one or more of the operations set forth by FIGS. 2, 9, and 10 described below. It should also be noted that while FIG. 1 illustrates one example of a configuration of an apparatus 100, numerous other configurations may also be used to implement embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

Referring to FIG. 1, the apparatus 100 in accordance with one example embodiment may include or otherwise be in communication with one or more of a processor 102, a memory 102, a communication interface circuitry 106, and user interface circuitry 108.

In some embodiments, the processor (and/or co-processors or any other processing circuitry assisting or otherwise associated with the processor) may be in communication with the memory device via a bus for passing information among components of the apparatus. The memory device may include, for example, a non-transitory memory, such as one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor 102. Additionally or alternatively, the memory device could be configured to store instructions for execution by the processor.

In some embodiments, the apparatus 100 may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 102 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 102 may be configured to execute instructions stored in the memory device 104 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA, or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device configured to employ an embodiment of the present invention by further configuration of the processor by instructions for performing the algorithms and/or operations described herein. The processor may include, among other things, a clock, an arithmetic logic unit (ALU), and logic gates configured to support operation of the processor.

Meanwhile, the communication interface 106 may be any means such as a device or circuitry embodied in either hardware or a combination of hardware and software that is configured to receive and/or transmit data from/to a network and/or any other device or module in communication with the apparatus 100. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

The apparatus 100 may include user interface 108 that may, in turn, be in communication with the processor 102 to provide output to the user and, in some embodiments, to receive an indication of a user input. For example, the user interface may include a display and, in some embodiments, may also include a keyboard, a mouse, a joystick, a touch screen, touch areas, soft keys, a microphone, a speaker, or other input/output mechanisms. The processor may comprise user interface circuitry configured to control at least some functions of one or more user interface elements such as a display and, in some embodiments, a speaker, ringer, microphone, and/or the like. The processor and/or user interface circuitry comprising the processor may be configured to control one or more functions of one or more user interface elements through computer program instructions (e.g., software and/or firmware) stored on a memory accessible to the processor (e.g., memory 104, and/or the like).

In the past two decades, many non-rigid techniques have been proposed. Most of these techniques are based on minimizing an energy function containing a distance (or similarity) measure and a regularization term. The regularization encourages certain types of transformation related to different applications. The minimum distance should correspond to the correct spatial alignment. One of the most successful distance measures is based on the mutual information (MI) of images (see Paul Viola and William M. Wells III, “Alignment by maximization of mutual information”, International Journal of Computer Vision, vol. 24, no. 2, pp. 137-154, 1997). However, in many real-world applications, the intensity fields of two images may vary significantly. For example, slow-varying intensity bias fields often exist in remote-sensing images. As a result, many existing intensity-based distance measures are not robust to these intensity distortions.

Although some methods are proposed for simultaneous registration and intensity correction, they often involve much higher computation complexity and suffer from multiple local minima. Recently, the sparsity-inducing similarity measures have been repeatedly successful in overcoming such registration difficulties. All of these methods assume that the large errors among the images are sparse (e.g., caused by shadows, partial occlusions) and separable. However, many real-world images contain severe spatially-varying intensity distortions. These intensity variations are not sparse and therefore difficult to be separated by these methods. As a result, the above measures may fail to find the correct alignment and thus are less robust in these challenging tasks.

Embodiments of the present invention provide a novel method for intensity based multi-image registration of multiple images based on deep sparse representation of the images. Image gradients or edges are much more stationary than image pixels under spatially-varying intensity distortions. Based on this, a new similarity measure is provided to match the edges of multiple images. Unlike previous techniques that vectorize each image into a vector, embodiments of the present invention arrange the input images into a 3D tensor to keep their spatial structure. With this arrangement, the optimally registered image tensor can be deeply sparsified into a sparse frequency tensor and a sparse error tensor, as discussed in regard to FIG. 2. Severe intensity distortions and partial occlusions will be sparsified and separated out in the first and second layers, while any misalignment will increase the sparseness of the frequency tensor (third layer). Embodiments of the present invention provide a novel similarity measure based on such deep sparse representation of the natural images. An efficient algorithm based on the Augmented Lagrange Multiplier (ALM) method is provided to solve this problem. Experimental results on several synthetic and real-world applications demonstrate that the methods of the embodiments outperform the state-of-the-art in terms of robustness, accuracy, and efficiency.

FIG. 2 illustrates an example of deep sparse representation of the optimally registered images as provided by embodiments of the present invention. First the image tensor is sparsified into the gradient tensor (1st layer). The sparse error tensor is then separated out in the 2nd layer. The gradient tensor with repetitive patterns is then sparsified in the frequency domain. Finally, an extremely sparse frequency tensor (composed of Fourier coefficients) is obtained in the 3rd layer.

An example of robust multi-image registration as provided by embodiments of the present invention will now be described in further detail.

In an example embodiment, a batch of grayscale images, I₁, I₂, . . . , I_{N}εR^{w×h}, are to be registered, where N denotes the total number of images. First, the simplest case is considered that all the input images are identical and perturbed from a set of transformations τ={τ₁, τ₂, . . . , τ_{N}} (it can be affine, non-rigid, etc.). All the images are arranged into a 3D tensor D with size w×h×N and D_{(:,:,t)}=Iₜ, ∀t=1, 2, . . . , N.

The provided methods come from the intuition that the locations of the image gradients (edges) should almost remain the same, even under severe intensity distortions. After removing the transformation perturbations, the slices show repetitive patterns. Such periodic signals are extremely sparse in the frequency domain. Ideally, the Fourier coefficients from the second slice to the last slice should be all zeros. The L1 norm of the Fourier coefficients can be minimized to seek the optimal transformations. Therefore, we register the images using the deep sparse representation:

$${min}_{A , E , τ} {‖ {F}_{N} A ‖}_{1} + λ {‖ E ‖}_{1} , subject to ∇ D ∘ τ = A + E , \qquad ( 1 )$$

where F_{N} denotes Fourier transform in the third direction, ∇D∘τ=[vec(I₁⁰), vec(I₂⁰), . . . , vec(I_{N}⁰)] is M by N real matrix, vec(x) denotes vectorizing the image x, ∇D=\sqrt{(∇ₓD)²+(∇_{y}D)²} denotes the gradient along two spatial directions; vec(Iₜ⁰) denotes image Iₜ warped by τₜ for t=1, 2, . . . , N, A represents the aligned images, and E denotes the sparse error. This is based on a mild assumption that the intensity distortion fields of natural images often change smoothly.

Based on the first order Taylor expansion, the equation (1) can be rewritten as:

$${min}_{A , E , Δτ} {‖ {F}_{N} A ‖}_{1} + λ {‖ E ‖}_{1} , subject to ∇ D ∘ τ + J ⊗ Δτ = A + E . \qquad ( 2 )$$

The Jocobian Jₜ is a w×h×p tensor and it is the parameter of p dimension. Here the tensor product [symbol] is defined as: given a n₁×n₂×n₃ tensor A and a vector b of n₃dimension, then A [symbol] b=C, where C is a n₁×n₂ matrix and C_{(i,j)}=Σₜ₌₁ⁿ^{₃}A_{(i,j,t)}bₜ ∀i=1, . . . , n₁ and ∀j=1, . . . , n₂. This constrained problem can be solved by the augmented Lagrange multiplier (ALM) algorithm.

The augmented Lagrangian problem is to iteratively update A, E, Δτ and Y by

$$( {A}^{k + 1} , {E}^{k + 1} , {Δτ}^{k + 1} ) = arg {min}_{A , E , Δτ} L ( A , E , Δτ , Y ) , \\ {Y}^{k + 1} = {Y}^{k} + {µ}^{k} h ( {A}^{k} , {E}^{k} , {Δτ}^{k} ) \qquad ( 3 )$$

where k is the iteration counter and

$$\begin{matrix}L ( A , E , Δτ , Y ) = < Y , h ( A , E , Δτ ) > + {‖ {F}_{N} A ‖}_{1} + λ {‖ E ‖}_{1} + \frac{µ}{2} {‖ h ( A , E , Δτ ) ‖}_{F}^{2} & ( 4 ) \\ h ( A , E , Δτ ) = ∇ D ∘ τ + J ⊗ Δτ - A - E & ( 5 )\end{matrix}$$

Here, <x, y> represents inner product of x and y. A common strategy to solve (3) is to minimize the function against one unknown at one time. Each of the sub-problems has a closed form solution:

$$\{ \begin{matrix}{A}^{k + 1} = {T}_{\frac{{ }_{1}}{{µ}^{k}}} ( ∇ D ∘ τ + J ⊗ Δτ + \frac{{ }_{1}}{{µ}^{k}} {Y}^{k} - {E}^{k} ) \\ {E}^{k + 1} = {T}_{\frac{{ }_{λ}}{{µ}^{k}}} ( ∇ D ∘ τ + J ⊗ Δτ + \frac{{ }_{1}}{{µ}^{k}} {Y}^{k} - {A}^{k + 1} ) \\ {Δτ}_{t}^{k + 1} = {J}_{t}^{+} ⊗ ( {A}_{( \text{:} , \text{:} , t )}^{k + 1} + {E}_{( \text{:} , \text{:} , t )}^{k + 1} + {D}_{( \text{:} , \text{:} , t )}^{k + 1} ∘ τ - \frac{{ }_{1}}{{µ}_{k}} {Y}_{( \text{:} , \text{:} , t )}^{k} ) , \\ ∀ t = 1 , … , N\end{matrix} , \qquad ( 6 )$$

where Jₜ⁺ is the Moore-Penrose pseudoinverse of Jₜ, T_{α} denotes the soft thresholding operation with threshold value α.

T_{α}=sign(x)max(|x|−α,0) (7)

The registration algorithm for the multiple images is summarized in Algorithm 1. Let M=w×h be the number of pixels of each image. We set

$$λ = \frac{1}{\sqrt{M}} and {µ}_{k} = {1.25}^{k} {µ}_{0}$$

in the experiments, where

$${µ}_{0} = \frac{1.25}{{‖ ∇ D ‖}_{2}} .$$

Algorithm 1: Deep Sparse Representation for Multi-Image Registration Input: I₁, . . . , I_{N} are the 2D images. τ₁, . . . , τ_{N} are initial values for transformation parameters. λ is the regularization parameter.
Output: The transformation parameter τ, aligned images A, and registration error E.
   Repeat
      (1) Compute

$${J}_{t} = \frac{\partial }{\partial ζ} ( ∇ {I}_{t} ∘ ζ ) {\vert}_{ζ = {τ}_{t}} , t = 1 , … , N ;$$

(2) Warp and normalize the gradient images: ∇D∘τ=

$$[ \frac{∇ {I}_{1} ∘ {τ}_{1}}{{‖ ∇ {I}_{1} ∘ {τ}_{1} ‖}_{F}} ; … ; \frac{∇ {I}_{N} ∘ {τ}_{N}}{{‖ ∇ {I}_{N} ∘ {τ}_{N} ‖}_{F}} ] ;$$

(3) Use equation (6) to iteratively solve the minimization problem of

$$ALM \text{:} ( {A}^{*} , {E}^{*} , {Δτ}^{*} ) = arg {min}_{A , E , Δτ} L ( A , E , Δτ , Y ) ,$$

(4) Update τ=τ+Δτ*;
Until stop criterions.

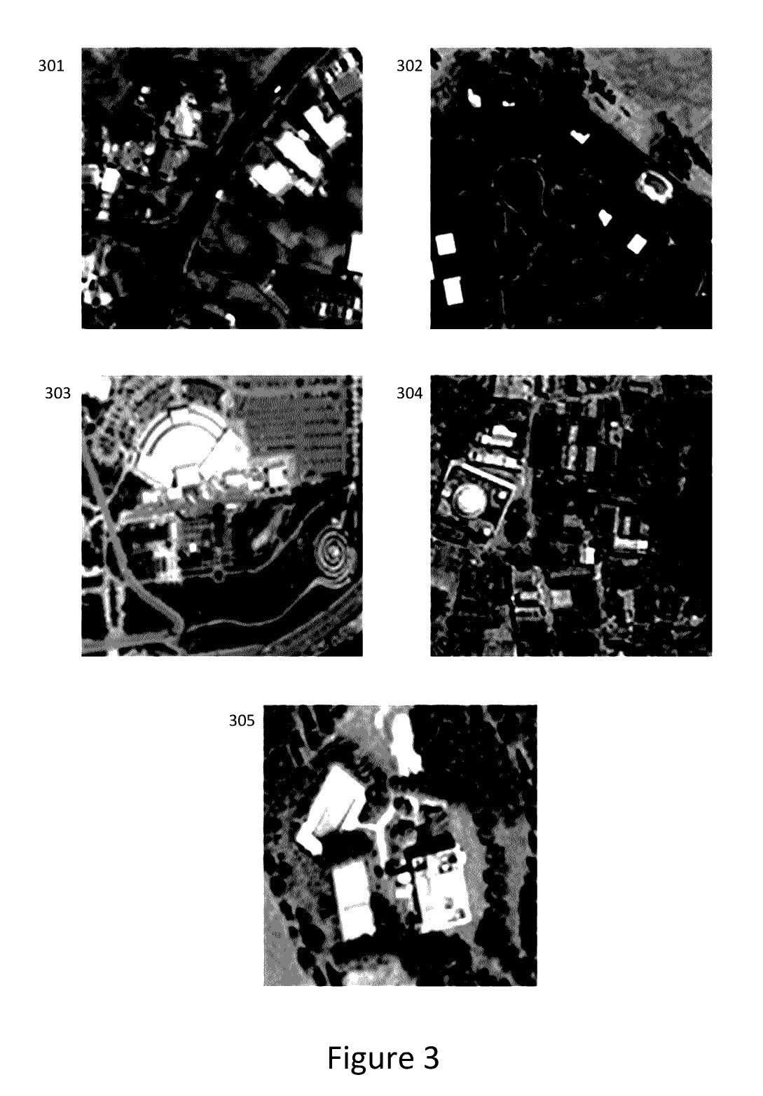

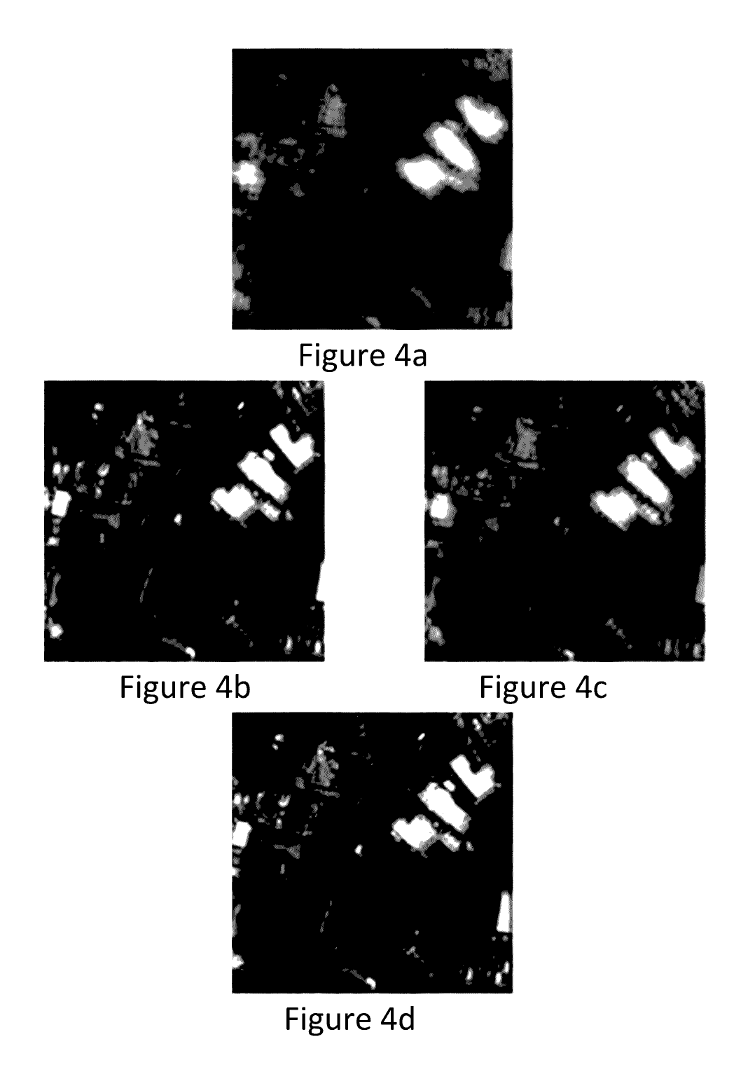

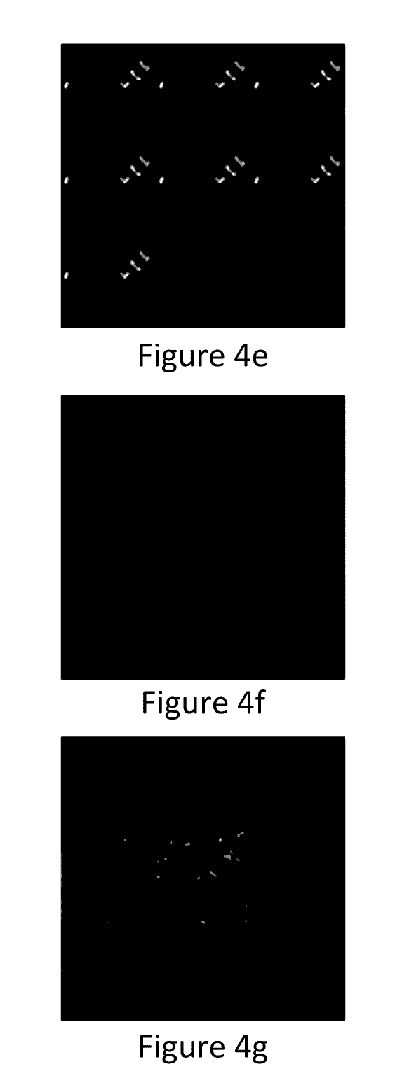

To evaluate the performance of the provided registration algorithm, several images cropped from Quickbird and GeoEye are used, as illustrated in FIG. 3. FIG. 3 illustrates five examples of images, image 301 to image 305, that are used in providing the example registration results sets illustrated in FIGS. 4a to 8g.

Artificial translation and light changes are added to each channel of images and each channel is treated as a single grayscale image. The translation is drawn randomly from a uniform distribution. For each test case, eight misaligned images are used. Then several different registration algorithms are performed to register the images. The technique provided in an example embodiment is compared with two state-of-the-art techniques: RASL and t-GRASTA.

FIGS. 4a-g through 8a-g illustrate five example registration result sets for the different image datasets as provided in FIG. 3.

FIGS. 4a through 4g illustrate a first registration result using the first of the GeoEye datasets (represented by image 301 of FIG. 3). FIG. 4a illustrates an average image of the input image set. It can be observed in FIG. 4a that because of misalignment, the image is extremely blurred. FIG. 4b illustrates the average image of the registration result using RASL for the image registration. FIG. 4c illustrates the average image of the registration result using t-GRASTA for the image registration. FIG. 4d illustrates the average image of the registration result using an embodiment of the present invention for the image registration.

The average images provided by the registrations, illustrated in FIGS. 4b through 4d, are much clearer than the average image illustrated in FIG. 4a. Within the three sample average images resulting from the registration techniques, it can be seen that the average image produced using the example embodiment has significantly sharper edges than the average images provided by the prior methods.

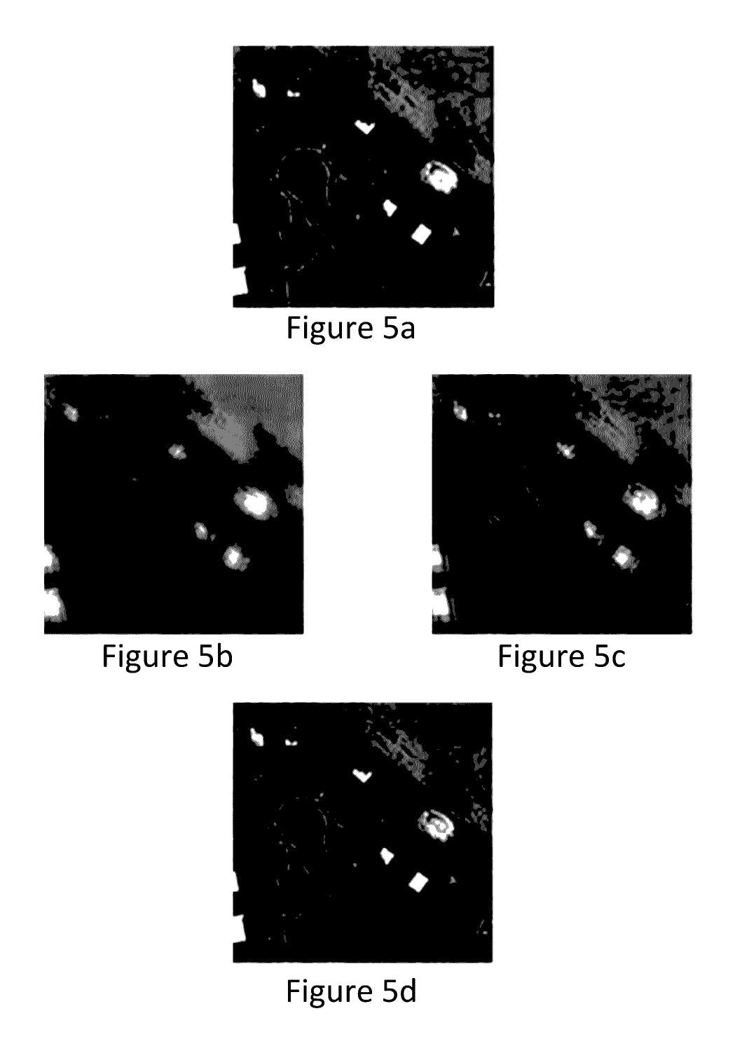

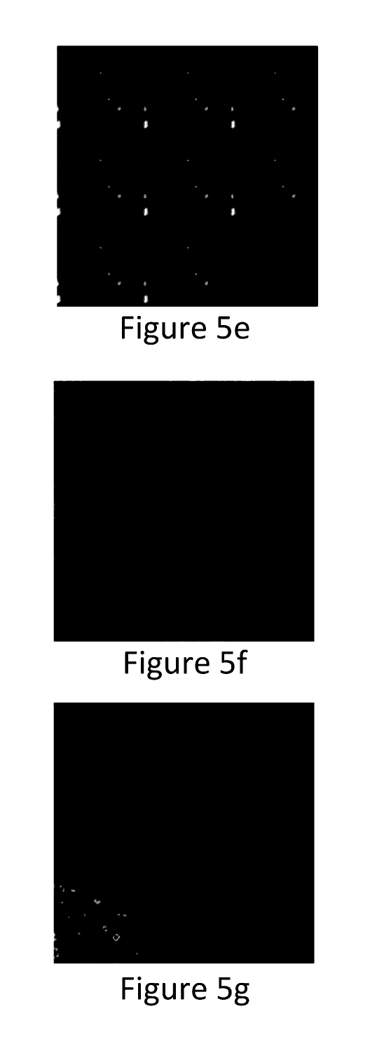

FIGS. 4e through 4g illustrate the sparse errors output by various registration techniques. FIG. 4e illustrates the sparse errors resulting from RASL. FIG. 4f illustrates the sparse errors resulting from t-GRASTA. FIG. 4g illustrates the sparse errors resulting from the example embodiment. As can be seen, RASL and t-GRASTA fail to separate the shadows and large errors and mistake many good pixels for error. The example embodiment on the other hand can successfully find the optimal registration of the images. Similar trends can also be observed in FIGS. 5 through 8.

FIGS. 5a through 5g illustrate a registration result using the second of the GeoEye datasets (represented by image 302 of FIG. 3). FIG. 5a illustrates an average image of the input image set. FIG. 5b illustrates the average image of the registration result using RASL for the image registration. FIG. 5c illustrates the average image of the registration result using t-GRASTA for the image registration. FIG. 5d illustrates the average image of the registration result using the example embodiment for the image registration.

Only in some cases is the average image provided by the registrations, illustrated in FIGS. 5b through 5d, clearer than the average image illustrated in FIG. 5a. Within the three sample average images resulting from the registration techniques, it can again be seen that the average image produced using the example embodiment has significantly sharper edges than the average images provided by the prior methods.

FIGS. 5e through 5g illustrate the sparse errors output by various registration techniques. FIG. 5e illustrates the sparse errors resulting from RASL. FIG. 5f illustrates the sparse errors resulting from t-GRASTA. FIG. 5g illustrates the sparse errors resulting from the example embodiment. As shown again, RASL and t-GRASTA fail to separate the shadows and large errors and mistake many good pixels for error. The example embodiment on the other hand can successfully find the optimal registration of the images.

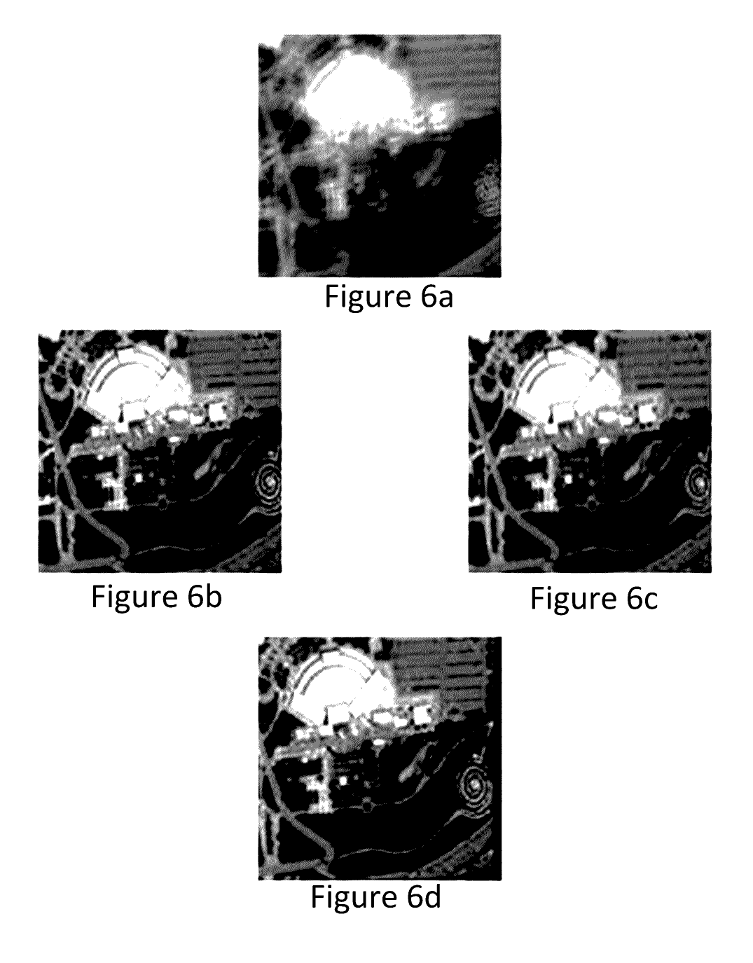

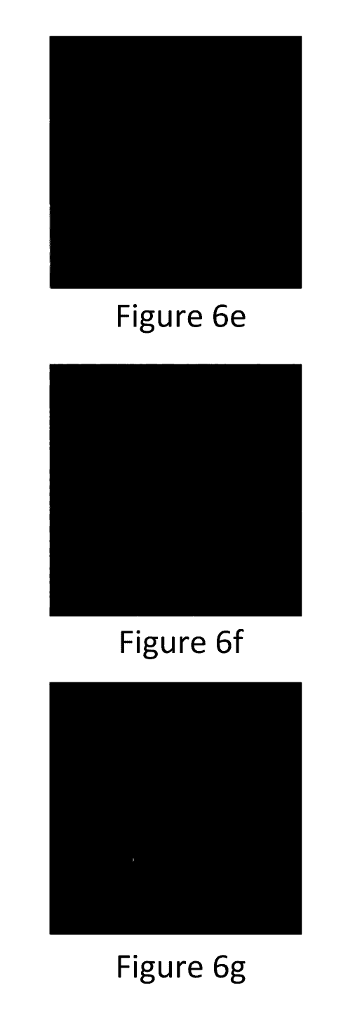

FIGS. 6a through 6g illustrate a registration result using the third of the GeoEye datasets (represented by image 303 of FIG. 3). FIG. 6a illustrates an average image of the input image set. Again, it can be observed in FIG. 6a that because of misalignment, the image is extremely blurred. FIG. 6b illustrates the average image of the registration result using RASL for the image registration. FIG. 6c illustrates the average image of the registration result using t-GRASTA for the image registration. FIG. 6d illustrates the average image of the registration result using the example embodiment for the image registration.

The average images provided by the registrations, illustrated in FIGS. 6b through 6d, are again much clearer than the average image illustrated in FIG. 6a. Within the three sample average images resulting from the registration techniques, it can again be seen that the average image produced using the example embodiment has sharper edges than the average images provided by the prior methods.

FIGS. 6e through 6g illustrate the sparse errors output by various registration techniques. FIG. 6e illustrates the sparse errors resulting from RASL. FIG. 6f illustrates the sparse errors resulting from t-GRASTA. FIG. 6g illustrates the sparse errors resulting from the example embodiment. As can be seen, RASL and t-GRASTA may fail to separate the shadows and large errors and mistake many good pixels for error. The example embodiment on the other hand can successfully find the optimal registration of the images.

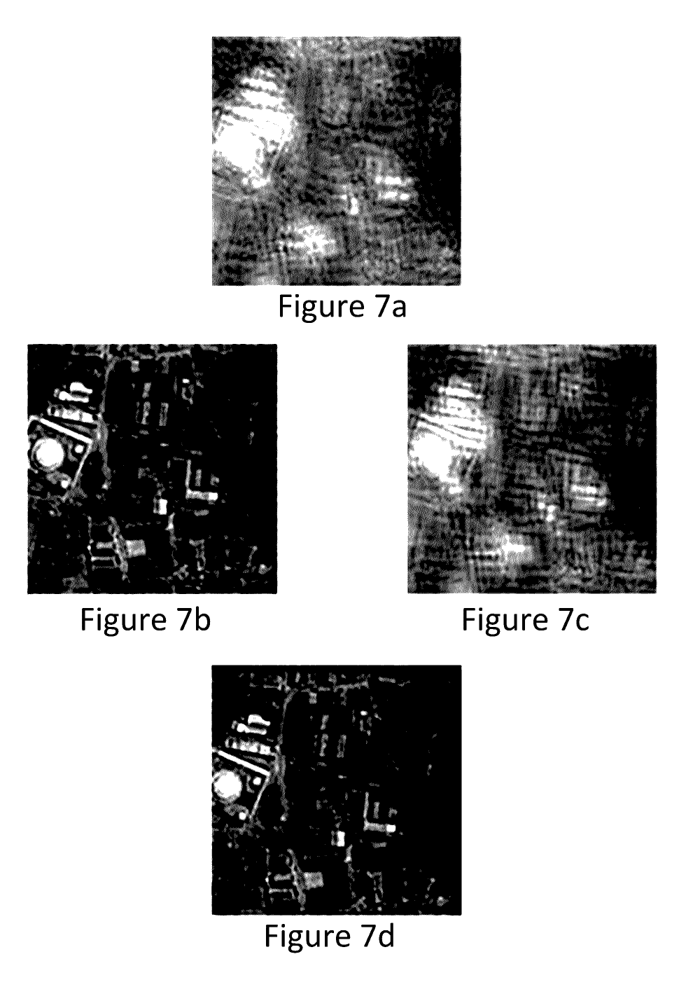

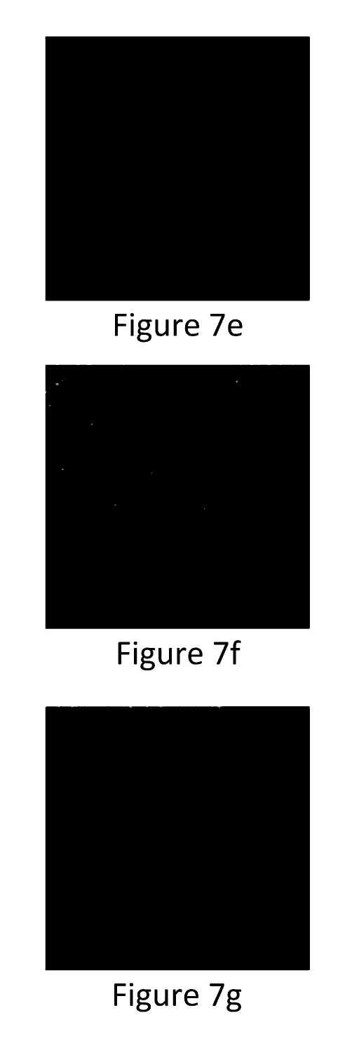

FIGS. 7a through 7g illustrate a registration result using the fourth of the GeoEye datasets (represented by image 304 of FIG. 3). FIG. 7a illustrates an average image of the input image set. Again, it can be observed in FIG. 7a that because of misalignment, the image is extremely blurred. FIG. 7b illustrates the average image of the registration result using RASL for the image registration. FIG. 7c illustrates the average image of the registration result using t-GRASTA for the image registration. FIG. 7d illustrates the average image of the registration result using the example embodiment for the image registration.

The average images provided by the registrations, illustrated in FIGS. 7b through 7d, may be much clearer than the average image illustrated in FIG. 7a in some cases. Within the three sample average images resulting from the registration techniques, it can again be seen that the average image produced using the example embodiment has sharper edges than the average images provided by the prior methods.

FIGS. 7e through 7g illustrate the sparse errors output by various registration techniques. FIG. 7e illustrates the sparse errors resulting from RASL. FIG. 7f illustrates the sparse errors resulting from t-GRASTA. FIG. 7g illustrates the sparse errors resulting from the example embodiment.

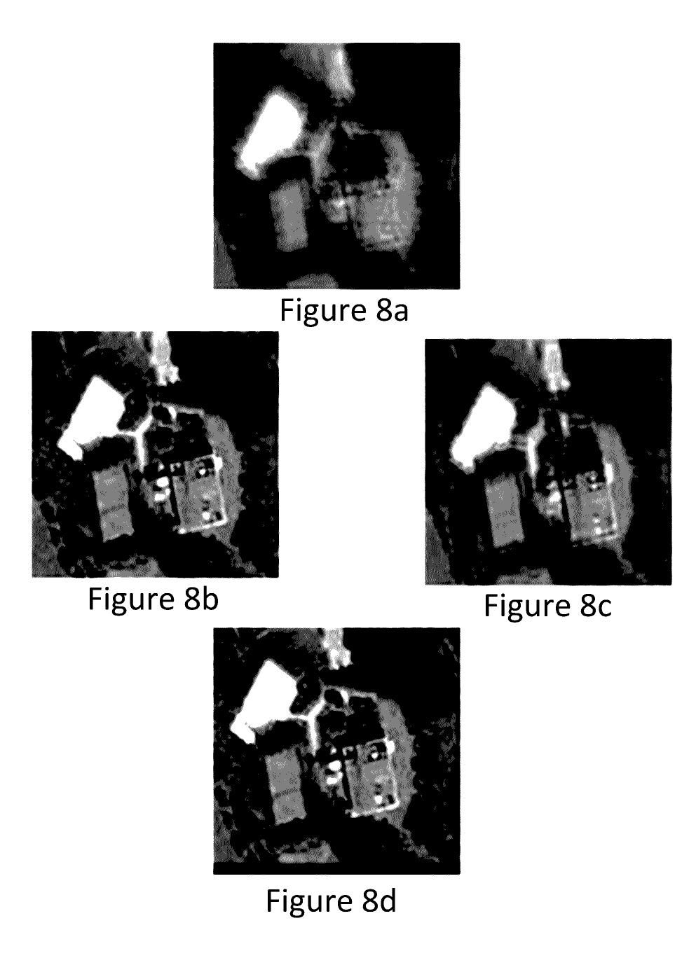

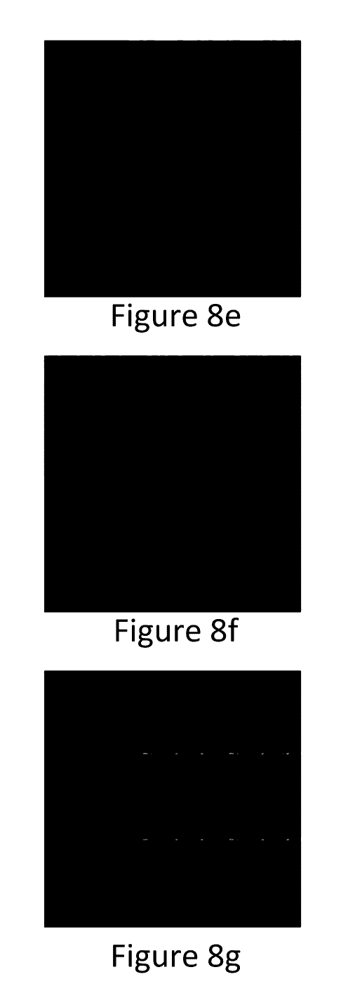

FIGS. 8a through 8g illustrate a registration result using a first Quickbird dataset (represented by image 305 of FIG. 3). FIG. 8a illustrates an average image of the input image set. Again, it can be observed in FIG. 8a that because of misalignment, the image is extremely blurred. FIG. 8b illustrates the average image of the registration result using RASL for the image registration. FIG. 8c illustrates the average image of the registration result using t-GRASTA for the image registration. FIG. 8d illustrates the average image of the registration result using the example embodiment for the image registration.

The average images provided by the registrations, illustrated in FIGS. 8b through 8d, may be much clearer than the average image illustrated in FIG. 8a in some cases. Within the three sample average images resulting from the registration techniques, it can again be seen that the average image produced using the example embodiment has sharper edges than the average images provided by the prior methods.

FIGS. 8e through 8g illustrate the sparse errors output by various registration techniques. FIG. 8e illustrates the sparse errors resulting from RASL. FIG. 8f illustrates the sparse errors resulting from t-GRASTA. FIG. 8g illustrates the sparse errors resulting from the example embodiment.

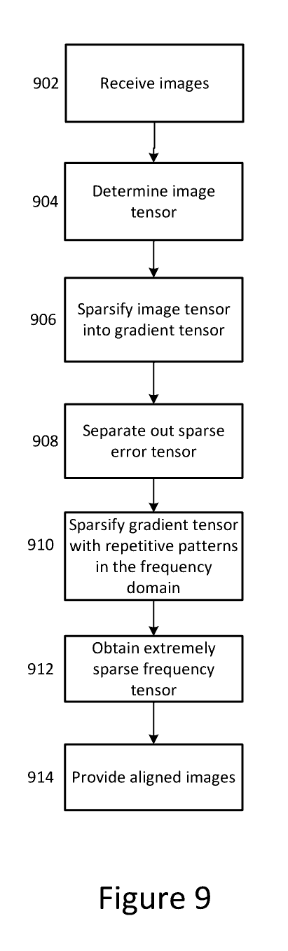

FIG. 9 provides a flow chart illustrating example operations for robust image registration based on deep sparse representation for multi-image registration in accordance with an example embodiment of the present invention.

In this regard, an apparatus, such as apparatus 100, may include means, such as the processor 102, memory 104, communication interface 106, user interface 108, or the like, for performing robust multi-image registration based on deep sparse representation. As shown in block 902 of FIG. 9, the apparatus may include means, such as the processor 102, memory 104, communication interface 106, user interface 108, or the like, for receiving a batch of images to be registered. For example, the apparatus may receive N two-dimensional images that are to be registered. As shown in block 904, the apparatus 100 may include means, such as processor 102, memory 104, communication interface 106, user interface 108, or the like, for determining a three-dimensional image tensor.

As shown in block 906, the apparatus 100 may also include means, such as the processor 102, memory 104, communication interface 106, user interface 108, or the like, for sparsifying the image tensor into a gradient tensor. At block 908, the apparatus 100 may also include means, such as the processor 102, memory 104, communication interface 106, user interface 108, or the like, for separating out the spare error tensor (sparse decomposition).

As shown in block 910, the apparatus 100 may also include means, such as the processor 102, memory 104, communication interface 106, user interface 108, or the like, for sparsifying the gradient tensor with repetitive patterns in the frequency domain. At block 912, the apparatus 100 may also include means, such as the processor 102, memory 104, communication interface 106, user interface 108, or the like, for obtaining an extremely sparse frequency tensor.

As shown in block 912, the apparatus 100 may also include means, such as the processor 102, memory 104, communication interface 106, user interface 108, or the like, for providing the aligned images.

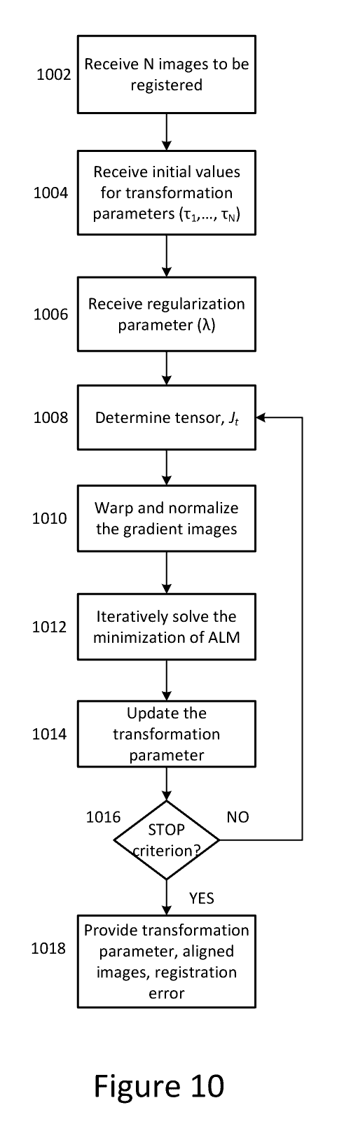

FIG. 10 provides a flow chart further illustrating example operations for robust image registration based on deep sparse representation for multi-image registration in accordance with an example embodiment of the present invention.

In this regard, an apparatus, such as apparatus 100, may include means, such as the processor 102, memory 104, communication interface 106, user interface 108, or the like, for performing robust multi-image registration based on deep sparse representation. As shown in block 1002 of FIG. 10, the apparatus may include means, such as the processor 102, memory 104, communication interface 106, user interface 108, or the like, for receiving a plurality of images to be registered. For example, the apparatus may receive N two-dimensional images that are to be registered. As shown in block 1004, the apparatus 100 may include means, such as processor 102, memory 104, communication interface 106, user interface 108, or the like, for receiving a plurality of initial values for transformation parameters, for example, transformation parameters τ₁, . . . , τ_{N}. As shown in block 1006, the apparatus 100 may include means, such as processor 102, memory 104, communication interface 106, user interface 108, or the like, for receiving regularization parameter.

As shown in block 1008, the apparatus 100 may also include means, such as the processor 102, memory 104, communication interface 106, user interface 108, or the like, for computing the tensor Jₜ, where

$${J}_{t} = \frac{\partial }{\partial ζ} ( ∇ {I}_{t} ∘ ζ ) {\vert}_{ζ = {τ}_{t}} , t = 1 , … , N .$$

At block 1010, the apparatus 100 may also include means, such as the processor 102, memory 104, communication interface 106, user interface 108, or the like, for warping an normalizing the gradient images. As shown in block 1012, the apparatus 100 may also include means, such as the processor 102, memory 104, communication interface 106, user interface 108, or the like, for iteratively solving the minimization problem of ALM;

$$( {A}^{*} , {E}^{*} , {Δτ}^{*} ) = arg {min}_{A , E , Δτ} L ( A , E , Δτ , Y ) .$$

At block 1014, the apparatus 100 may also include means, such as the processor 102, memory 104, communication interface 106, user interface 108, or the like, for updating the transformation parameter τ, for example using τ=τ+Δτ*.

As shown in block 1016, the apparatus 100 may also include means, such as the processor 102, memory 104, communication interface 106, user interface 108, or the like, for determining whether a stop criterion for the process has been reached. [Could you provide some example or further explanation of what a stop criterion might be?] If a stop criterion has not been reached, the process returns to block 1008 and repeats. If a stop criterion has been reached, the process continues to block 1018. At block 1018, the apparatus 100 may also include means, such as the processor 102, memory 104, communication interface 106, user interface 108, or the like, for providing the aligned images, the ending transformation parameter, and the registration error.

As described above, FIGS. 2, 9, and 10 illustrate flowcharts of an apparatus, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as shown by the blocks with dashed outlines. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
receiving a plurality of images to be registered;
determining, by a processor, an image tensor based on the received plurality of images;
sparsifying, by the processor, the image tensor into a gradient tensor;
separating out a sparse error tensor from the gradient tensor;
sparsifying the gradient tensor in a frequency domain; and
obtaining an extremely sparse frequency tensor.

2. The method of claim 1 wherein determining the image tensor further comprises arranging the plurality of images into a three-dimensional tensor having a size w×h×N.

3. The method of claim further comprising providing a transformation parameter, a plurality of aligned images, and a registration error.

4. The method of claim 1 further comprising registering the plurality of images using a deep sparse representation provided by
$${min}_{A , E , τ} {‖ {F}_{N} A ‖}_{1} + λ {‖ E ‖}_{1} , subject to ∇ D ∘ τ = A + E ,$$
where F_{N} denotes Fourier transform in a third direction,
∇D∘τ=[vec(I₁⁰), vec(I₂⁰), . . . , vec(I_{N}⁰)] is a M by N real matrix, vec(x) denotes vectorizing an image x, ∇D=\sqrt{(∇ₓD)²+(∇_{y}D)²} denotes a gradient along two spatial directions, vec(Iₜ⁰) denotes image Iₜ warped by τₜ for t=1, 2, . . . , N, A represents the aligned images, and E denotes the sparse error.

5. The method of claim 4 wherein the deep sparse representation imposes a sparse constraint on Fourier coefficients of A, the matrix of aligned images.

6. The method of claim 1 wherein the plurality of images to be registered comprise remote-sensing images.

7. The method of claim 1 wherein sparsifying the image tensor into the gradient tensor and separating out the sparse error tensor from the gradient tensor comprises sparsifying and separating out severe intensity distortions and partial occlusions.

8. An apparatus comprising at least one processor and at least one memory including computer program instructions, the at least one memory and the computer program instructions, with the at least one processor, causing the apparatus at least to:
receive a plurality of images to be registered;
determine an image tensor based on the received plurality of images;
sparsify the image tensor into a gradient tensor;
separate out a spare error tensor from the gradient tensor;
sparsify the gradient tensor in a frequency domain; and
obtain an extremely sparse frequency tensor.

9. The apparatus of claim 8 wherein determining the image tensor further comprises arranging the plurality of images into a three-dimensional tensor having a size w×h×N.

10. The apparatus of claim 8 further comprising the at least one memory and the computer program instructions, with the at least one processor, causing the apparatus to provide a transformation parameter, a plurality of aligned images, and a registration error.

11. The apparatus of claim 8 further comprising the at least one memory and the computer program instructions, with the at least one processor, causing the apparatus to register the plurality of images using a deep sparse representation provided by
$${min}_{A , E , τ} {‖ {F}_{N} A ‖}_{1} + λ {‖ E ‖}_{1} , subject to ∇ D ∘ τ = A + E ,$$
where F_{N} denotes Fourier transform in a third direction,
∇D∘τ=[vec(I₁⁰), vec(I₂⁰), . . . , vec(I_{N}⁰)] is a M by N real matrix, vec(x) denotes vectorizing an image x, ∇D=\sqrt{(∇ₓD)+(∇_{y}D)²} denotes a gradient along two spatial directions, vec(Iₜ⁰) denotes image Iₜ warped by τₜ for t=1, 2, . . . , N, A represents the aligned images, and E denotes the sparse error.

12. The apparatus of claim 11 wherein the deep sparse representation imposes a sparse constraint on Fourier coefficients of A, the matrix of aligned images.

13. The apparatus of claim 8 wherein the plurality of images to be registered comprise remote-sensing images.

14. The apparatus of claim 8 wherein sparsifying the image tensor into the gradient tensor and separating out the sparse error tensor from the gradient tensor comprises sparsifying and separating out severe intensity distortions and partial occlusions.

15. A computer program product comprising at least one non-transitory computer-readable storage medium bearing computer program instructions embodied therein for use with a computer, the computer program instructions comprising program instructions, when executed, causing the computer at least to:
receive a plurality of images to be registered;
determine an image tensor based on the received plurality of images;
sparsify the image tensor into a gradient tensor;
separate out a spare error tensor from the gradient tensor;
sparsify the gradient tensor in a frequency domain; and
obtain an extremely sparse frequency tensor.

16. The computer program product of claim 15 wherein determining the image tensor further comprises arranging the plurality of images into a three-dimensional tensor having a size w×h×N.

17. The computer program product of claim 15 further comprising the computer program instructions comprising program instructions, when executed, causing the computer to provide a transformation parameter, a plurality of aligned images, and a registration error.

18. The computer program product of claim 15 further comprising the computer program instructions comprising program instructions, when executed, causing the computer to register the plurality of images using a deep sparse representation provided by
$${min}_{A , E , τ} {‖ {F}_{N} A ‖}_{1} + λ {‖ E ‖}_{1} , subject to ∇ D ∘ τ = A + E ,$$
where F_{N} denotes Fourier transform in a third direction,
∇D∘τ=[vec(I₁⁰), vec(I₂⁰), . . . , vec(I_{N}⁰)] is a M by N real matrix, vec(x) denotes vectorizing an image x, ∇D=\sqrt{(∇ₓD)²+(∇_{y}D)²} denotes a gradient along two spatial directions, vec(Iₜ⁰) denotes image Iₜ warped by τₜ for t=1, 2, . . . , N, A represents the aligned images, and E denotes the sparse error.

19. The computer program product of claim 18 wherein the deep sparse representation imposes a sparse constraint on Fourier coefficients of A, the matrix of aligned images.

20. The computer program product of claim 15 wherein the plurality of images to be registered comprise remote-sensing images.

21. (canceled)

22. (canceled)

23. (canceled)

24. (canceled)

25. (canceled)

26. (canceled)

27. (canceled)

28. (canceled)
